(19) United States
(12) Patent Application Publication
(10) Pub. No.: US 2020/0296812 A1
(43) Pub. Date: Sep. 17, 2020

(54) SYSTEM, METHOD, AND CONTROLLER FOR TURNING ON A LOW-DIMMING LIGHT SOURCE RAPIDLY

(71) Applicant: iDESYN Semiconductor Corp., Zhubei City (TW)

(72) Inventor: SHIH-HSUEH YANG, Zhubei City (TW)

(21) Appl. No.: 16/815,568

(22) Filed: Mar. 11, 2020

(30) Foreign Application Priority Data
Mar. 13, 2019 (TW) 108108472

(51) Int. Cl. H05B 45/325; H05B 45/10

(52) U.S. Cl. CPC H05B 45/325; H05B 45/10

(57) ABSTRACT

The present invention provides a system for turning on a low-dimming light source rapidly, comprising: a light-emitting diode (LED) driving circuit and a control circuit. The LED driving circuit includes a power source module and an LED module provided at a rear end of the power source module, wherein the LED module is connected to a filter capacitor. The control circuit is connected to the filter capacitor through a feedback circuit in order to obtain an operating voltage value of the filter capacitor, outputs a control signal to a current control module based on a difference between the operating voltage value of the filter capacitor and a threshold voltage value, and is switched to a fast charging mode or a regular output mode according to the control signal and then modulates an output current of the power source module accordingly.

### BACKGROUND OF THE INVENTION

### 1. Technical Field

The present invention relates to a system and method for turning on a low-dimming light source rapidly. More particularly, the invention relates to a system and method for charging the filter capacitor in a light-emitting diode (LED) driving circuit rapidly so that the LED module to be driven can reach its turn-on voltage value within a short time.

### 2. Description of Related Art

Nowadays, LEDs have been widely used in various household lighting devices thanks to the advancement of technology, especially the breakthroughs in white LED technology. As a high-performance light source, LEDs have gradually replaced the conventional incandescent lamps and fluorescent lamps and become the mainstream in the lighting market.

To enhance the output stability of LEDs, it is common practice to connect a high-capacity capacitor to the output stage of an LED driving circuit. When the light to be output is low-dimming light (i.e., when the output is a low-current one), however, charging the capacitor can be so time-consuming that it takes a very long time to turn on the LED(s) in question; as a result, the user may misjudge the LED(s) as malfunctioning. The aforesaid problem is attributable mainly to the property of the operating voltage of the LED(s). While the capacitor is being charged, and before the voltage of the capacitor reaches the operating voltage of the LED(s), the LED(s) remains in the cut-off state and is therefore unable to emit light because, although supplied with electricity, the LED(s) does not have enough voltage.

### BRIEF SUMMARY OF THE INVENTION

The primary objective of the present invention is to provide a system for turning on a low-dimming light source rapidly, comprising: an LED driving circuit and a control circuit. The LED driving circuit includes a power source module and an LED module provided at a rear end of the power source module, wherein the LED module is connected to a filter capacitor. The control circuit includes a voltage detection module, a threshold voltage comparison module, and a current control module. The voltage detection module is connected to the filter capacitor through a feedback circuit in order to obtain an operating voltage value of the filter capacitor. The threshold voltage comparison module includes a threshold voltage value that is set according to the LED module and, based on a difference between the operating voltage value of the filter capacitor and the threshold voltage value, output a control signal to the current control module. The current control module is provided between the power source module and the LED module and is configured to be switched to a fast charging mode or a regular output mode according to the control signal and then modulate an output current of the power source module accordingly.

Another objective of the present invention is to provide a method for turning on a low-dimming light source rapidly, wherein the method is applied to the foregoing LED driving circuit, comprising: a power source module and an LED module provided at a rear end of the power source module, and the LED module is connected to a filter capacitor. The method includes: obtaining an operating voltage value of the filter capacitor through a control circuit; comparing the operating voltage value with a threshold voltage value by the controller; and switching the controller to a fast charging mode or a regular output mode according to a comparison result, in order for the controller to determine an output current of the power source module accordingly.

Still another objective of the present invention is to provide a controller or a plurality of such controllers, wherein the controller(s) is configured to load a program from a storage unit and execute the program so as to perform the above method.

Yet another objective of the present invention is to provide a controller for use with an LED driving circuit, wherein the LED driving circuit comprises a power source module and an LED module provided at a rear end of the power source module and connected to a filter capacitor. The controller includes an input end and an output end. The input end is connected to the filter capacitor, in order to obtain an operating voltage of the filter capacitor. When the operating voltage obtained by the input end has yet to reach a threshold voltage value, the output end is switched to a fast charging mode, in which the output end provides a relatively large current output. When the operating voltage obtained by the input end reaches the threshold voltage value, the output end is switched to a regular output mode to provide a relatively stable output, wherein the threshold voltage value is lower than a turn-on voltage value of the LED module.

The present invention provides a system and method that can turn on a low-dimming light source rapidly by fast charging the filter capacitor in the light source driving circuit when the light source driving circuit is switched on from the off state.

### BRIEF DESCRIPTION OF THE SEVERAL VIEWS OF THE DRAWINGS

FIG. 1 is a block diagram of a system for turning on a low-dimming light source rapidly according to the present invention.

FIG. 2 shows the driving voltage of the LED.

FIG. 3 is a block diagram of the control circuit implemented as a controller according to the present invention.

FIG. 4 is a circuit diagram of the first embodiment of the feedback circuit of the present invention.

FIG. 5 is a circuit diagram of the second embodiment of the feedback circuit of the present invention.

FIG. 6 is a circuit diagram of the third embodiment of the feedback circuit of the present invention.

FIG. 7 is a flowchart of the method for turning on a low-dimming light source rapidly according to the present invention.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

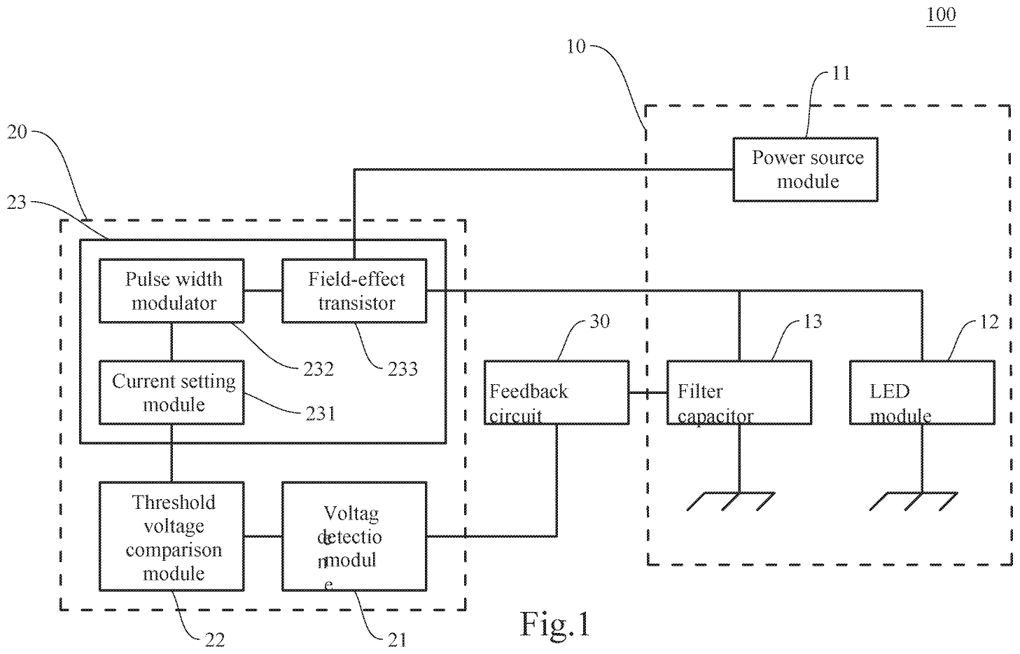

A detailed description of some illustrative embodiments of the present invention is given below. Please refer to FIG. 1 for a block diagram of a system for turning on a low-dimming light source rapidly according to the invention.

The embodiment shown in FIG. 1 discloses a system 100 for turning on a low-dimming light source rapidly. The system 100 essentially includes an LED driving circuit 10 and a control circuit 20 connected to the LED driving circuit 10.

The LED driving circuit 10 essentially includes a power source module 11 and an LED module 12 provided at the rear end of the power source module 11. The LED module 12 is connected to a filter capacitor 13. The filter capacitor 13 is connected in parallel to the LED module 12 and serves to provide a stable bias voltage to the LED module 12 after being charged.

The control circuit 20 essentially includes a voltage detection module 21, a threshold voltage comparison module 22, and a current control module 23. To facilitate circuit design, it is feasible to integrate the voltage detection module 21, the threshold voltage comparison module 22, and the current control module 23 into a single chip. Alternatively, selected functions of one or more of the modules can be performed by separate chips respectively. The present invention has no limitation on the number of chips used to implement the voltage detection module 21, the threshold voltage comparison module 22, and the current control module 23. The aforesaid chips may include, for example but not limited to, a central processing unit (CPU), a programmable general-purpose or application-specific microprocessor, a digital signal processor (DSP), an application-specific integrated circuit (ASIC), other similar devices, or a combination of the above.

The voltage detection module 21 is connected to the filter capacitor 13 through a feedback circuit 30 in order to obtain the operating voltage value of the filter capacitor 13. The design of the feedback circuit 30, though not a characterizing feature of the present invention, will be described in more detail below with reference to specific embodiments and the accompanying drawings. The voltage detection module 21 may be configured to modulate the operating voltage obtained and to output the modulated voltage to the threshold voltage comparison module 22 at its rear end in order to reduce the power consumption of the load.

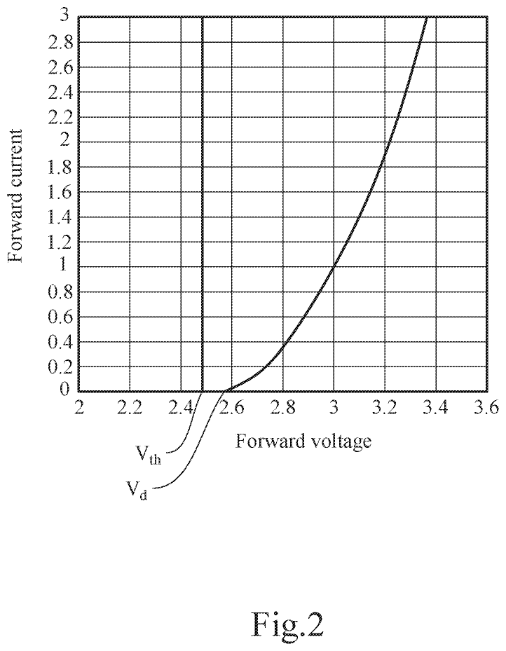

The threshold voltage comparison module 22 includes a threshold voltage value that is set according to the LED module 12. The threshold voltage comparison module 22 is connected to the output end of the voltage detection module 21 in order to obtain the operating voltage value of the filter capacitor 13 and, based on the difference between the operating voltage value of the filter capacitor 13 and the threshold voltage value, output a control signal to the current control module 23. In one embodiment, the threshold voltage comparison module 22 is a comparator whose positive and negative input ends are supplied respectively with the output of the voltage detection module 21 (which output may be the operating voltage value of the filter capacitor 13 as is or a modulated voltage) and the preset threshold voltage value, and which switches its output between high and low according to the comparison result of the two input values. To protect the LED module 12 in this embodiment, referring to FIG. 2, it is preferable that the threshold voltage value Vₜₕ is slightly lower than the turn-on voltage value (i.e., driving voltage value) V_{d} of the LED module 12, the objective being to ensure that the current control module 23 is switched from a fast charging mode to a regular output mode before the operating voltage value of the LED module 12 reaches that required for emitting low-dimming light. The setting of the threshold voltage value Vₜₕ depends mainly on the clock performance of the related chip(s) and the charging speed.

The current control module 23 is provided between the power source module 11 and the LED module 12 and is configured to be switched to the fast charging mode or the regular output mode according to the control signal and then modulate the output current of the power source module 11 accordingly. In one embodiment, the current control module 23 includes a current setting module 231, a pulse width modulator (PWM) 232, and a field-effect transistor (FET) 233 provided between the power source module 11 and the LED module 12. The current setting module 231, or more particularly its current outputs corresponding respectively to the activation of the fast charging mode and the activation of the regular output mode, are preset by the chip designer. The pulse width modulator 232 has its output connected to the gate of the field-effect transistor 233 and is configured to modulate the output of the current setting module 231, in order for the duty cycle or trigger frequency of the modulated pulses to determine the on and off time of the field-effect transistor 233 and consequently the current output by the power source module 11 to the LED module 12, thereby achieving the objective of current control.

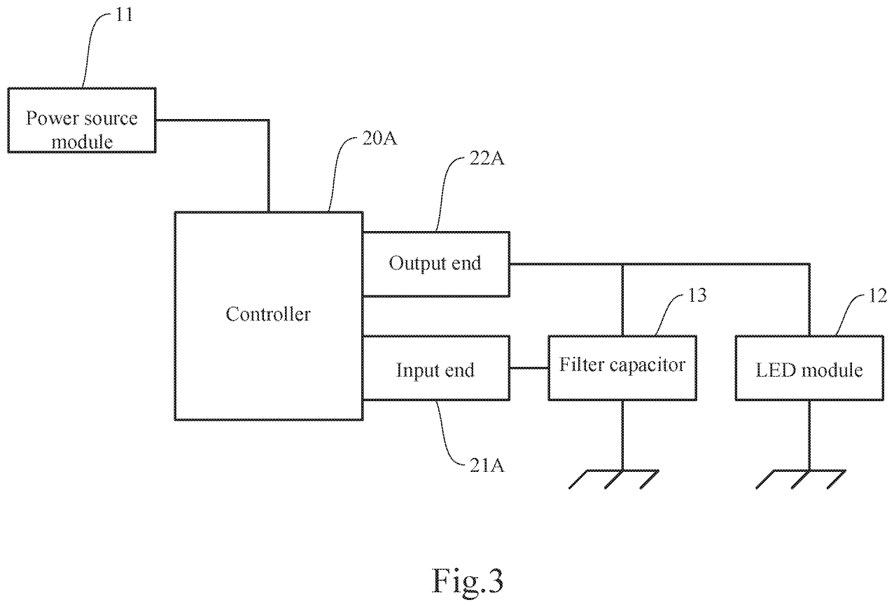

In one embodiment, the control circuit 20 is implemented as a single chip (e.g., a controller) or a microprocessor. Please refer to FIG. 3 for a block diagram of the control circuit implemented as a controller.

As shown in FIG. 3, the controller 20A includes at least one input end 21A (other necessary inputs such as the power source input Vcc are omitted herein for the sake of brevity) and at least one output end 22A. The input end 21A is connected to the filter capacitor 13 for the LED module 12, either directly or indirectly, in order to obtain the operating voltage of the filter capacitor 13. When the operating voltage obtained by the input end 21A has yet to reach the threshold voltage value, the output end 22A is switched to the fast charging mode, in which the output end 22A provides a relatively large current output. When the operating voltage obtained by the input end 21A reaches the threshold voltage value, the output end 22A is switched to the regular output mode to provide a relatively stable output. It should be pointed out that the threshold voltage value is lower than the turn-on voltage value of the LED module 12, so the controller 20A is switched from the fast charging mode to the regular output mode before the turn-on voltage value of the LED module 12 is reached. This allows the filter capacitor 13 to complete its charging process and be activated rapidly when the light to be output is low-dimming light. The “relatively large” current output provided by the output end 22A in the fast charging mode is in relative terms in comparison with the output current in the regular output mode. Similarly, the “relatively stable” output provided by the output end 22A in the regular output mode is in relative terms in comparison with the output current in the fast charging mode.

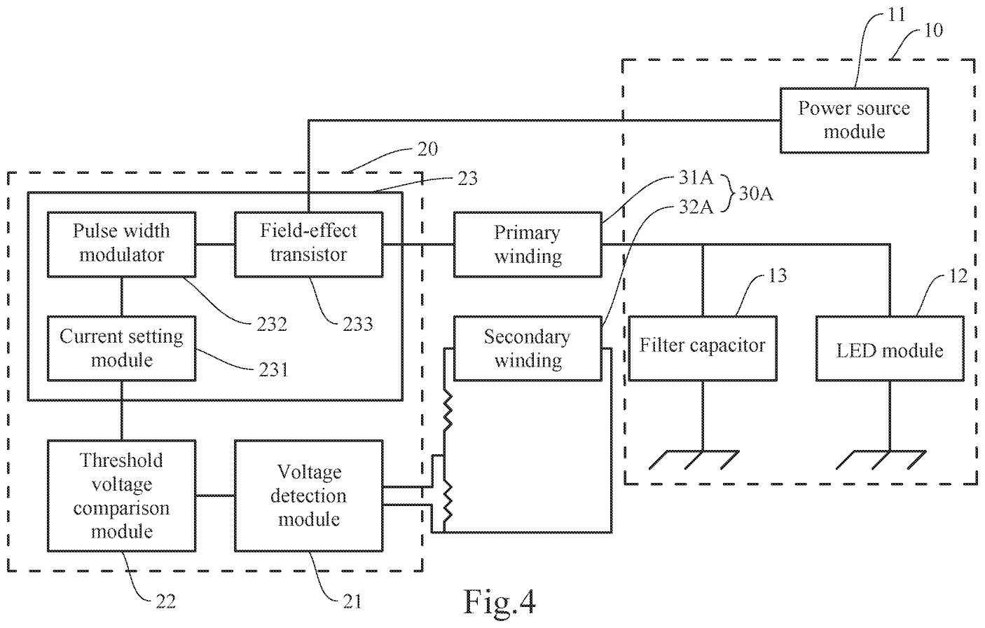

The following paragraphs describe various embodiments of the feedback circuit 30. The functional modules and circuits used in conjunction with those embodiments are the same as those illustrated in FIG. 1 and therefore will not be described repeatedly. Please refer to FIG. 4 for a circuit diagram of the first embodiment of the feedback circuit of the present invention.

In this embodiment, the feedback circuit 30A uses a pair of inductors to deliver as feedback to the voltage detection module 21 of the control circuit 20 the current output by the power source module 11 to the filter capacitor 13. More specifically, the feedback circuit 30A according to this embodiment includes a primary winding 31A and a secondary winding 32A. The primary winding 31A is connected in series to the filter capacitor 13. The secondary winding 32A is provided at the input end of the voltage detection module 21 and is coupled to the primary winding 31A such that the induced electromotive force generated by the primary winding 31A (i.e., the first inductor) acts on the secondary winding 32A (i.e., the second inductor). The voltage detection module 21 can obtain the operating voltage value of the filter capacitor 13 by detecting the voltage across the two ends of the secondary winding 32A or the current flowing through the secondary winding 32A.

In this embodiment, the primary winding 31A and the secondary winding 32A in the feedback circuit 30A can isolate the power source module 11 from the control circuit 20. The primary winding 31A also provides noise suppression.

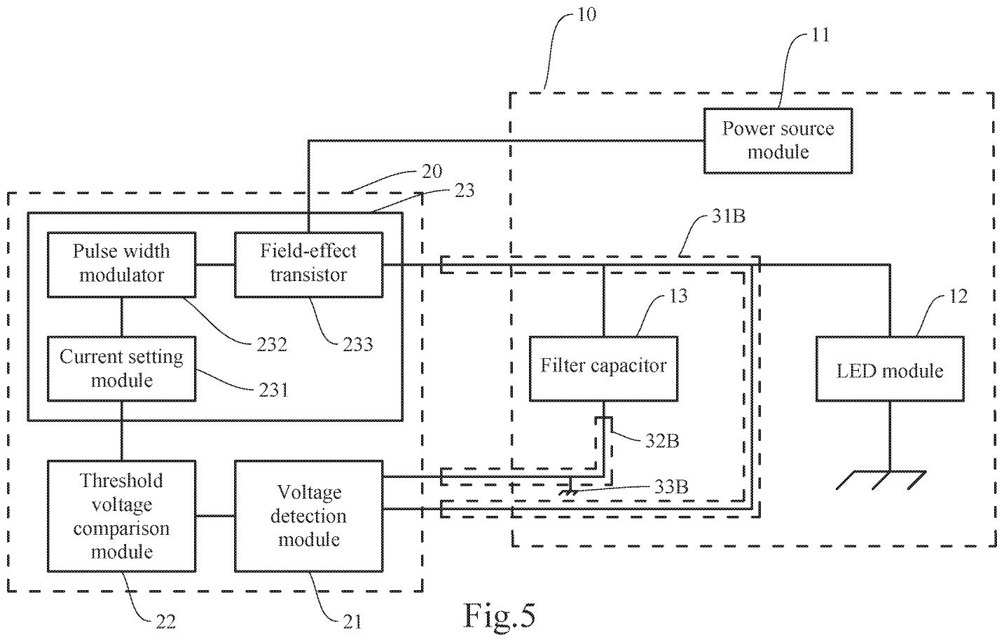

Please refer to FIG. 5 for the second embodiment of the feedback circuit of the present invention.

This embodiment provides a feedback circuit 30B that includes a first circuit 31B and a second circuit 32B. The first circuit 31B is connected to the high-voltage end of the filter capacitor 13 and the high-voltage end of the voltage detection module 21. The second circuit 32B is connected to the low-voltage end of the filter capacitor 13 and the low-voltage end of the voltage detection module 21. In addition, the second circuit 32B is electrically connected to a ground end 33B. By connecting the voltage detection module 21 and the filter capacitor 13 to a common ground, the voltage detection module 21 in this embodiment can directly obtain the operating voltage of the filter capacitor 13 as input.

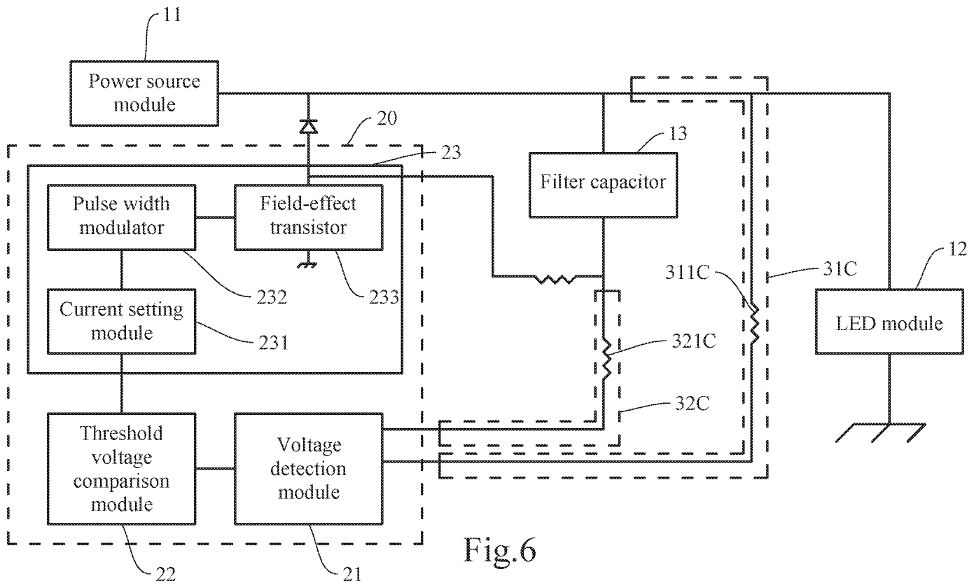

Please refer to FIG. 6 for the third embodiment of the feedback circuit of the present invention.

This embodiment provides a feedback circuit 30C that gives feedback to the voltage detection module 21 without having to connect the voltage detection module 21 and the filter capacitor 13 to a common ground. In terms of circuit configuration, the feedback circuit 30C includes a first circuit 31C and a second circuit 32C. The first circuit 31C is connected to the high-voltage end of the filter capacitor 13 and the high-voltage end of the voltage detection module 21 and is connected in series to a first load 311C. The second circuit 32C is connected to the low-voltage end of the filter capacitor 13 and the low-voltage end of the voltage detection module 21 and is connected in series to a second load 321C. Thus, the feedback circuit 30C, which does not connect the voltage detection module 21 and the filter capacitor 13 to a common ground, allows the voltage detection module 21 to obtain the voltage across the two ends of the filter capacitor 13.

The various embodiments described above are only some feasible and preferred ones of the present invention; the scope of the invention is not confined to the contents of those embodiments.

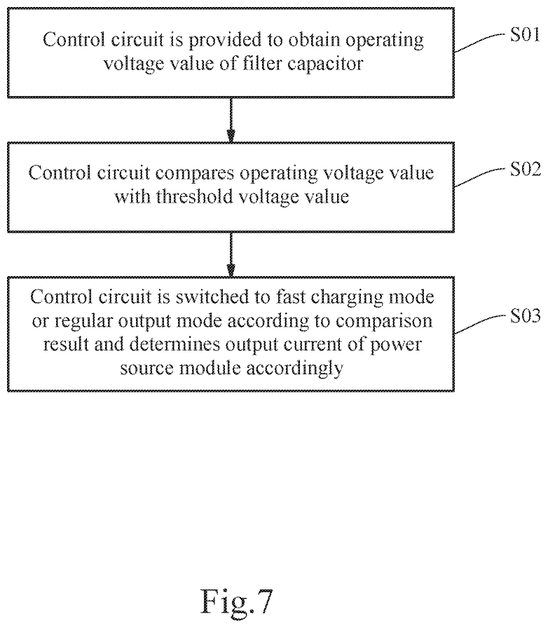

The present invention also provides a method for turning on a low-dimming light source rapidly as detailed below with reference to the accompanying drawings. Please refer to FIG. 7 in conjunction with FIG. 1 for a flowchart of the method for turning on a low-dimming light source rapidly according to the invention.

The embodiment shown in FIG. 7 discloses a method for turning on a low-dimming light source rapidly, wherein the method is applied to the foregoing LED driving circuit 10. As stated above, the LED driving circuit 10 includes the power source module 11 and the LED module 12, which is provided at the rear end of the power source module 11 and is connected to the filter capacitor 13. The method essentially includes the following steps:

Step S01: The control circuit 20, which is configured for obtaining the operating voltage value of the filter capacitor 13, is provided.

Step S02: The control circuit 20 compares the operating voltage value with a threshold voltage value, wherein the threshold voltage value is lower than the turn-on voltage value of the LED module 12.

Step S03: Based on the comparison result, the control circuit 20 is switched to a fast charging mode or a regular output mode and determines the output current of the power source module 11 accordingly. More specifically, upon detecting that the operating voltage value of the filter capacitor 13 is lower than the threshold voltage value, the control circuit 20 activates the fast charging mode in order for the filter capacitor 13 to be supplied, and thus charged, with a large current; and upon detecting that the operating voltage value of the filter capacitor 13 reaches the threshold voltage value, the control circuit 20 activates the regular output mode in order for the LED module 12 to be supplied with a stable current.

The method described above can be carried out by a single programmable controller or a plurality of such controllers, wherein the controller(s) is configured to load a program from a storage unit and execute the program so as to perform steps S01 to S03. The storage unit may be, for example, a non-transitory computer-readable recording medium.

In summary of the above, the present invention provides a system and method that can turn on a low-dimming light source rapidly by fast charging the filter capacitor in the light source driving circuit when the light source driving circuit is switched on from the off state.

The above is the detailed description of the present invention. However, the above is merely the preferred embodiment of the present invention and cannot be the limitation to the implement scope of the invention, which means the variation and modification according to the present invention may still fall into the scope of the invention.

What is claimed is:

1. A system for turning on a low-dimming light source rapidly, comprising:
a light-emitting diode (LED) driving circuit comprising a power source module and an LED module provided at a rear end of the power source module, wherein the LED module is connected to a filter capacitor; and
a control circuit comprising a voltage detection module, a threshold voltage comparison module, and a current control module, wherein the voltage detection module is connected to the filter capacitor through a feedback circuit in order to obtain an operating voltage value of the filter capacitor, the threshold voltage comparison module comprises a threshold voltage value set according to the LED module and is configured to output a control signal to the current control module according to a difference between the operating voltage value of the filter capacitor and the threshold voltage value, and the current control module is provided between the power source module and the LED module and is configured to be switched to a fast charging mode or a regular output mode according to the control signal and modulate an output current of the power source module accordingly.

2. The system of claim 1, wherein the threshold voltage value is lower than a turn-on voltage value of the LED module.

3. The system of claim 2, wherein the current control module includes a pulse width modulator (PWM) and a field-effect transistor (FET) provided between the power source module and the LED module, wherein the pulse width modulator has its output connected to the gate of the field-effect transistor and is configured to control an output current of the power source module.

4. The system of claim 1, wherein the feedback circuit includes a primary winding and a secondary winding, wherein the primary winding is connected in series to the filter capacitor, and the secondary winding is provided at an input end of the voltage detection module and is coupled to the primary winding.

5. The system of claim 1, wherein the feedback circuit includes a first circuit and a second circuit, wherein the first circuit is connected to a high-voltage end of the filter capacitor and a high-voltage end of the voltage detection module, and the second circuit is connected to a low-voltage end of the filter capacitor and a low-voltage end of the voltage detection module.

6. The system of claim 5, wherein the second circuit is electrically connected to a ground end.

7. The system of claim 5, wherein the first circuit is connected in series to a first load, and the second circuit is connected in series to a second load.

8. A method for turning on a low-dimming light source rapidly, wherein the method is applied to a light-emitting diode (LED) driving circuit, the LED driving circuit comprises a power source module and an LED module provided at a rear end of the power source module, and the LED module is connected to a filter capacitor, the method comprising the steps of:
obtaining an operating voltage value of the filter capacitor through a control circuit;
comparing the operating voltage value with a threshold voltage value by the controller; and
switching the controller to a fast charging mode or a regular output mode according to a comparison result, in order for the controller to determine an output current of the power source module accordingly.

9. The method of claim 8, wherein the threshold voltage value is lower than a turn-on voltage value of the LED module.

10. The method of claim 8, wherein the control circuit activates the fast charging mode in order for the filter capacitor to be supplied, and thus charged, with a large current upon the control circuit detects that the operating voltage value of the filter capacitor is lower than the threshold voltage value; and, the control circuit activates the regular output mode in order for the LED module to be supplied with a stable current upon the control circuit detects that the operating voltage value of the filter capacitor reaches the threshold voltage value.

11. A single programmable controller or a plurality of such controllers for loading a program from a storage unit and executing the program so as to perform the method of claim 8.

12. A controller for use with a light-emitting diode (LED) driving circuit, wherein the LED driving circuit comprises a power source module and an LED module provided at a rear end of the power source module, and the LED module is connected to a filter capacitor, the controller comprising:
an input end connected to the filter capacitor in order to obtain an operating voltage of the filter capacitor; and
an output end to be switched to a fast charging mode when the operating voltage obtained by the input end has yet to reach a threshold voltage value, and to a regular output mode when the operating voltage obtained by the input end reaches the threshold voltage value, wherein the output end provides a relatively large current output when in the fast charging mode and a relatively stable output when in the regular output mode, and the threshold voltage value is lower than a turn-on voltage value of the LED module.
